(19) United States
(12) Patent Application Publication
(10) Pub. No.: US 2010/0036880 A1
(43) Pub. Date: Feb. 11, 2010

(54) INTERACTIVE DATABASE DRIVEN MULTITENANCY SYSTEM

(76) Inventor: Lori A. Carpenter, Reno, NV (US)

Correspondence Address: Jeffery M. Lillywhite, PC, P.O. Box 1113, Draper, UT, 84020-1113, US

(21) Appl. No.: 12/478,754

(22) Filed: Jun. 4, 2009

Related U.S. Application Data
(60) Provisional application No. 61/058,804, filed on Jun. 4, 2008.

(51) Int. Cl. G06F 3/048; G06F 17/30

(52) U.S. Cl. 707/104.1; 715/764; 707/100; 707/E17.009

(57) ABSTRACT

In an interactive database driven multitenancy system, a method includes selecting a regional supplements to be used. An orthorectified aerial photograph is obtained for the selected regional supplements. The process overlays the photograph with a boundary of a selected project. Preliminary GIS data set of NWI, Soil, Hydrology, and TOPO is obtained from the system. A preliminary desktop and/or detail wetland delineation is conducted and reports and maps are generated.

### CROSS-REFERENCE TO RELATED APPLICATIONS

This application claims the benefit of U.S. Provisional Patent Application No. 61/058,804, entitled “Interactive Database Driven Multitenancy System,” filed Jun. 4, 2008, which is incorporated herein by reference.

### BACKGROUND OF THE INVENTION

1. The Field of the Invention

The invention is related to interactive database driven multitenancy system. More particularly, it is directed to web-based interactive database systems designed for wetland identification and delineation.

2. The Relevant Technology

Section 404 of the Clean Water Act regulates the discharge of dredged or fill material into waters of the United States (WOUS), including wetlands (see 33 CFR 320-330). Section 404 requires a permit before dredged or fill material may be discharged into WOUS. As part of the permit application process wetlands must be identified and delineated. This is done following the 1987 Corps of Engineers Wetlands Delineation Manual and Supplements to the manual, depending on the region where the project is located. The US Army Corps of Engineers (USACE or CORPS) and the US Environmental Protection Agency (USEPA) are the federal agencies enforcing Section 404 provisions. The US Fish and Wildlife Service and the National Marine Fisheries Service evaluate specific cases or policy issues pursuant to Section 404(q).

Wetland identification and delineation and the Section 404 permitting process is a rigorous procedure that not only involves understanding topics such as hydrology, geology (e.g., soils), and biology (e.g. vegetation) but up-to-date knowledge on regulations, policies, and rulings that affect how decisions are made. The database process contains many repetitive and redundant tasks that result in common mistakes that delay the CORPS approval process. Companies must hire and retain employees that are capable of understanding the science and regulations. These employees must not only keep up to date technically on the scientific process, but they need to keep current with ever changing policies and regulations.

Other software programs have been developed to help wetland delineators fill in data sheets but do not provide all the features and information required to conduct delineations and inform and guide individuals through the process. These other programs are not necessarily publicly available and do not allow individuals who are not technical experts to conduct wetland identification and delineations. Reportedly, the software is geared towards persons who are currently experts in the process. The existing programs do not simultaneously offer online interaction; good documentation and support; compatibility with recently updated USACE standards; national applicability; weekly/monthly updates; ease of use; support of field data collection; field data transfer; integration with Geographic Information Systems (GIS) and Remote Sensing (RS) technology, Global Positioning System (GPS), database technology, and visual formats; instant desktop delineation services; web GIS functions; data analysis capabilities; expandable forms; and wetland delineation training.

### BRIEF SUMMARY OF THE INVENTION

In an interactive database driven multitenancy system, a method includes selecting a regional supplement to be used. An orthorectified aerial photograph is obtained for the selected regional supplement. The process overlays the photograph with a boundary of a selected project. GIS data layers for National Wetland Inventory (NWI), soil, hydrography and topography (TOPO) are obtained by the system and results in preliminary desktop wetland delineation.

Another method for a detailed wetland delineation is also provided in an interactive database driven multitenancy system. The method includes inputting data from field surveys into a database. The data is analyzed and the system determines if the data meets wetland criteria for hydrophytic vegetation, soils and hydrology and if so, an affirmative value is assigned to that criterion and indicates that wetland conditions are met. Wetland conditions are present when all three indicators for vegetation, soils and hydrology are met.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

The following is a brief description of the figures used to illustrate the various embodiments of the invention.

FIG. 1 is a flowchart illustrating a set of operations used to interactively identify and delineate wetlands and automate the Section 404 process;

FIG. 2 illustrates an overview of the structure and the facilities of the system;

FIG. 3 is a flowchart illustrating operations and logic for identifying and delineating wetlands and map and report output;

FIGS. 4-9 are flowcharts illustrating the operations and logic for determining the hydrophytic vegetation, hydric soil and wetland hydrology indicators following the 1987 Corps of Engineers Wetlands Delineation Manual (1987 Manual) and the Arid West Supplement, respectively;

FIGS. 10-13 are the examples of the standardized data forms for 1987 Manual and Arid West Supplement; and

FIGS. 14-17 are examples of high resolution aerial photographs encompassing an area of interest (AOI), with survey plot locations, plots with determined indicators, and delineation of wetland boundaries, respectively.

### DETAILED DESCRIPTION OF THE VARIOUS EMBODIMENTS

In the following description, specific details are set forth to provide an expert system, supported by a database comprised of the scientific and regulatory knowledge, designed to perform wetland identification and delineation as well as drive the Section 404 permit application process. The system is directed to web-based interactive database software designed to allow individuals who are not experts in the wetland scientific field the ability to perform wetland identification and delineation. The system further helps individuals by automating the Section 404 process. This is done partly through a database comprised of the regulations and science (e.g. vegetation and soil characteristics) that is kept up-to-date to keep up with changing regulations and policies. A well designed knowledge base, for example, can be used to instantly and efficiently perform wetland indicator identification to delineate wetlands automatically.

Having access to this system will allow the professional, regulator, consultant, and public to complete tasks more efficiently with less effort. Less time and money will be spent implementing the process and keeping up to date on changing regulations. The invention will also allow persons of different backgrounds to have access to a resource tool that will remove repetitive and redundant tasks to reduce the time spent wading through the process and more time is spent on high level problems requiring human interaction.

The process can be accessed through a usage subscription to use the system for receiving wetland delineation service for an area of interest (AOI). The system is supported by a user interface, which allows users to submit project information, including the site location, site condition, and project boundary GIS layers. The user interface for this method may also be designed to include the ability for users to submit plot data using the USACE standardized data forms from all districts including regional supplements, such as Alaska Delineation Module, Arid West Delineation Module, Arizona, New Mexico Mountains Wetlands, Atlantic and Gulf Coastal Plain Module, California Wetlands, Caribbean Islands Module, Columbia Snake River Basin Wetlands, Great Plains Module, Hawaii and Pacific Islands Module, Interior Deserts Wetlands, LRRB Wetlands, Mediterranean California Wetlands, Eastern Mountains and Piedmont Module, Midwest Module, Northcentral and Northeast Module, Pacific Islands Module, Sierra Nevada Mountains Wetlands, Western Mountains Valleys & Coast Module. This includes the interactive ability for users to decide which regional wetland delineation methodology to follow (e.g. 1987 Manual, regional wetlands, and/or regional supplement) and which module to use based on information from the knowledge base included with the system. Users may make the decision and select the manual and method from a drop-down list that refers to the regulations stored in the knowledge base.

The system may include a designed user interface for service request, data submitting, report and maps downloading, and 404 submitting. The system may further include 1) a web server, which hosts web pages for user access for submitting information, interacting the wetland delineation proceeding, and requesting report and maps; 2) a database server, which hosts the knowledge base and rules database for the expert system, the spatial database for environmental data and the data point database; and 3) a processing server, which contains and executes the programs/software for implementing the above described method embodiments. The system may also include GIS or GPS, Personnel Digital Assistant (PDA), Printer, Plotter and Scanner to be used in the above method embodiments.

The process begins by selecting a delineation manual, module, and method to be used for the region where the AOI is located. This includes the interactive ability for users to decide which wetland delineation manual to follow (e.g. 1987 Manual or regional supplement) and which module to use based on information from the knowledge base. Users may make the decision and select the manual and method from a drop-down list that refers to the regulations stored in the knowledge base.

The system obtains high resolution aerial images encompassing the AOI and saves to a spatial imagery database. The system includes a mechanism to compare, recommend and obtain the aerial imagery from a complete list of vendors.

The system then obtains background spatial data comprising environmental data, such as US Fish and Wildlife Service (USFWS) NWI, Natural Resources Conservation Service (NRCS) hydric soils and other vegetation, and hydrography data, which is retrieved and linked to the AOI through a spatial database. The system is designed to organize and store this preliminary data in a spatial database and imagery database that can be used for preliminary desktop wetland delineations.

The system first conducts a preliminary desktop wetland delineation within GIS in the AOI based on the selected manual and method, the aerial images, and the background spatial data discussed above. This includes the option to create a preliminary wetland delineation map that users can utilize for decision making purposes.

Users may also input and upload field data and survey results to the system through multiple interfaces (GPS/GIS units, desktop computers, PDA and handheld devices, and the like). The users may interactively access the data forms and input plot survey data that is stored in the database server.

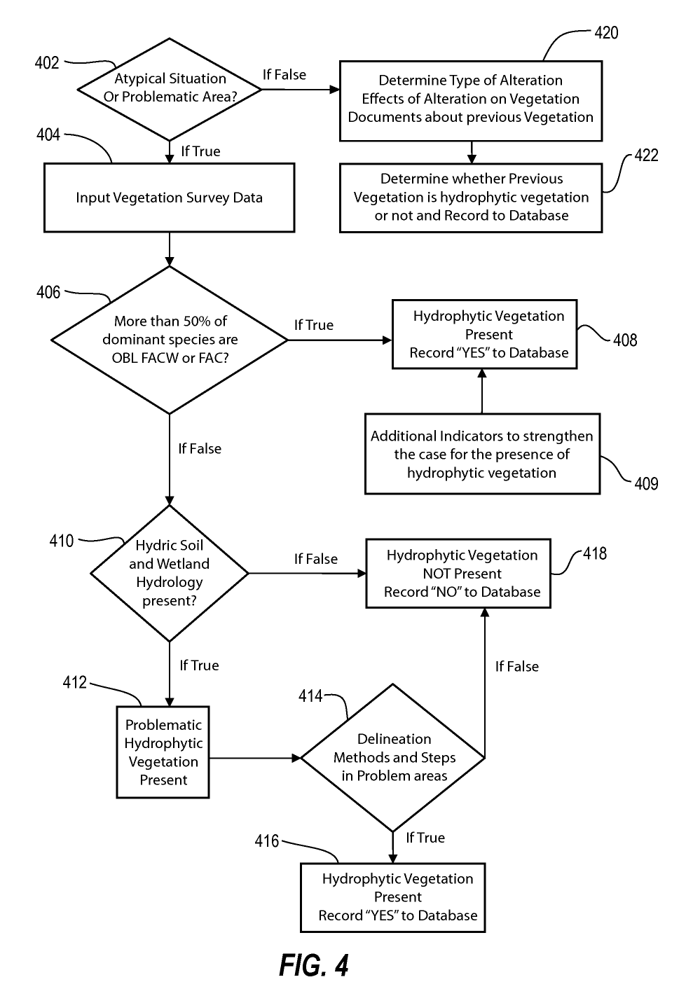

The wetland is identified interactively through the database driven expert system. The expert system includes procedures and rules used to determine the areas of hydrophytic vegetation presence, hydric soil presence, and wetland hydrology presence for the field survey plots entered for the AOI (see FIGS. 4, 5, and 6 for the 1987 Manual, and 7, 8, and 9 for the Arid West supplement).

The knowledge base is provided to efficiently perform wetland indicator identification in a manner that overcomes many of the inefficiencies and associated monetary and time-cost under the current techniques in current practices. The system instantly provides users with the knowledge, instruction and judgments to facilitate the process effectively.

Flowcharts illustrating procedures and rules used by the expert system for the 1987 Manual and the Arid West Supplement are found in FIGS. 4 through 6 and 7 through 9, respectively. Scientific and regulatory knowledge stored in the database is utilized by the expert system to determine the presence of these indicators and thus identify the wetland automatically.

The system further identifies and delineates the wetland boundaries based on GPS or GIS records obtained from field delineation of wetland boundaries. The boundaries can be further adjusted by the wetland and non-wetland plots and the results of interpretation of the high resolution aerial photograph and RS technology. This includes the ability of the expert system to delineate wetland boundaries based on aerial imagery interpretation or classification using rules and the knowledge base.

The standardization of the plot data report and the wetland delineation map are automated within the database and the GIS. The resulting report and maps may be viewed, downloaded, and printed. The resulting report and maps can be utilized as part of the Section 404 process.

The Section 404 application process is automated to produce a workable product including the project information, the wetland delineation report and wetland delineation maps. The option is included to prepare and submit the documents together with the delineation report and the maps as part of the Section 404 application process.

The invention design includes a web-based user interface for subscriptions or service requests using a web server; a knowledge base using a database server; and data inputting and uploading, mapping and report downloading and output using a processing server. The invention is designed to include the ability to integrate with GPS, GIS, PDAs, Printers, Plotters and Scanners and other known devices for uploading, downloading, and printing data and results.

The system includes a web server to host the user interface for input and output. A web interface is used for user access to accommodate information submittal, interaction with the wetland identification and delineation procedures, and requesting reports and maps. The input interface is designed for service requests, project information submittal, and report and map viewing, downloading and printing. A database server houses the knowledge base and rules database that drive the expert system. The spatial database houses spatial environmental data, spatial field data points, and the imagery database for the high resolution aerial photographs. The servers can include, for example, multiple storage stacks to accommodate additional storage and capacity as information and user traffic increases.

A processing server can be used to store and execute programs and software for implementing the process. For example, the system may include a GIS software package, RS software package, and/or database package. The processing server runs the processes to analyze, classify aerial photographs, synthesize GIS data layers, analyze data, generate reports and maps. The server may be used to interface with systems including GPS/GIS and a PDA for field data collection, data submission and map viewing as well as printers, plotters and scanners.

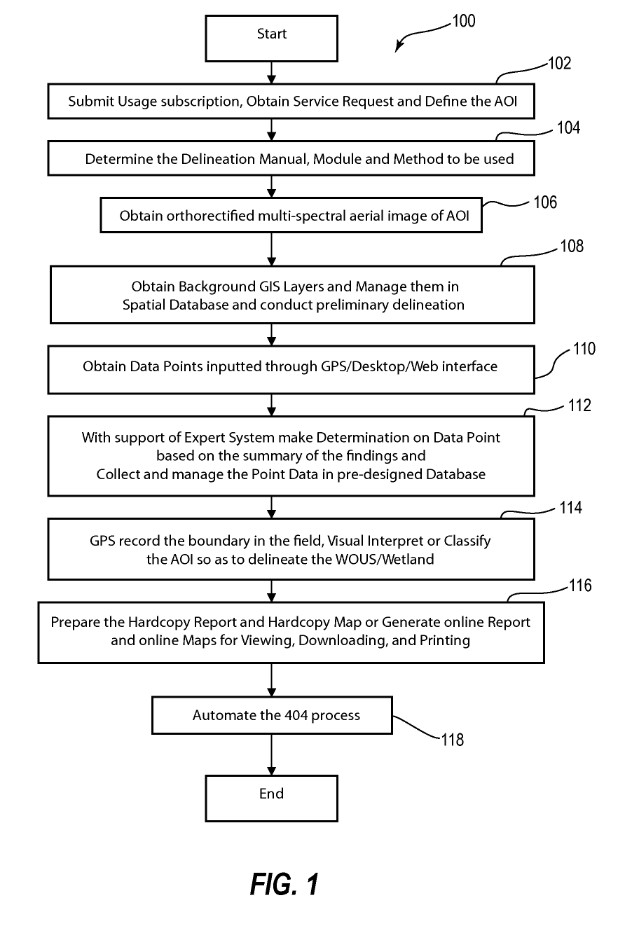

FIG. 1 illustrates a flowchart of a process of delineating wetland and automating the 404 process. The process may include obtaining service request and project information in step 102. In step 104, the process may further include obtaining user input on the decision of the delineation manual and module to be used. Users may make the decision and select the manual and method from a drop-down list, referring to the regulations stored in the knowledge base. The process in step 106 may include obtaining orthorectified high resolution aerial photographs and overlaying the photograph with the project boundary. The invention may have a mechanism to compare, recommend and obtain the aerial imagery from a complete list of vendors. In step 108, the process may include obtaining preliminary data set, such as, NWI, Soil, Hydrology, TOPO or other data sources and the like, and conducting a preliminary desktop wetland delineation. The preliminary data set may be organized in spatial database and imagery database and may be used in the preliminary desktop delineation.

The system may contain and expand a data warehouse. The preliminary data set stored in the data warehouse may reduce the money and time-cost and speed up the process. The preliminary delineation may be conducted and may be applied to locate the survey transects and plots. And the preliminary delineation result may be used in the beginning of decision making processes.

In step 110, the process may further include obtaining field technician plot survey data. The user may interactively access the data form and input the plot survey data. The plot data may be stored in the database server. The process may further include identifying/determining wetland delineation indicators in hydrophytic vegetation, hydric soil, and wetland hydrology following three blocks of procedure, assisted by the knowledge base and rules from expert system in step 112. The process in step 114 may further include delineating the boundary of the Water of United States (WOUS)/Wetlands by either adjusting the boundaries, recorded in the field using GPS/GIS, or by drawing the boundaries by interpreting and classifying the high resolution aerial photographs using the RS technology. The process may further include preparing the plot data report and delineation maps following the designed template in step 116. The plot data report and delineation maps may be stored and be accessed for viewing, downloading, and printing. In step 118, the process may finally include automating the Section 404 process with the input project information, site condition, and the wetland delineation report and maps.

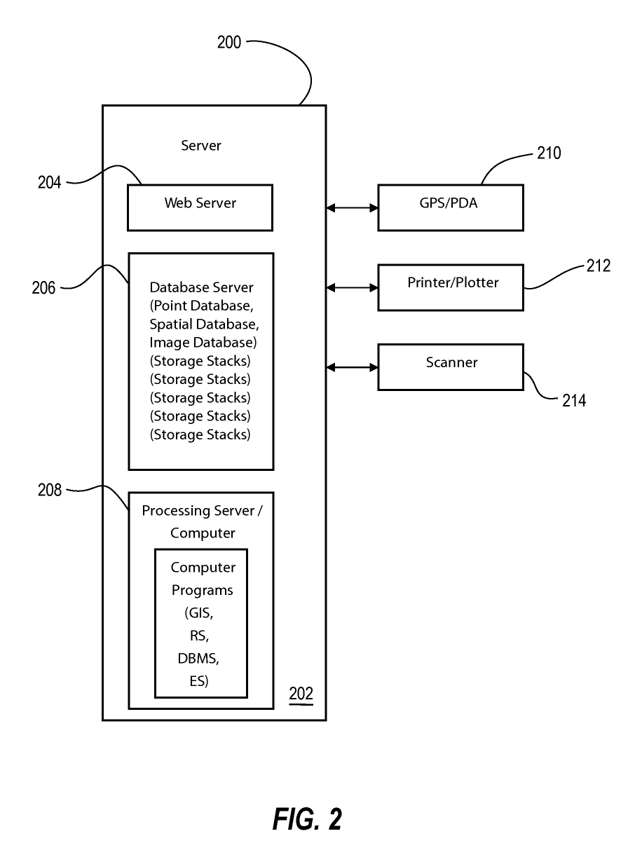

FIG. 2 shows a block diagram of a system 200 for web-based interactive wetland delineation and Section 404 process automation. The system 200 may include web server 204 to handle the input and output together with the programmed interface design. The system 200 may include database server 206, such as a server with multiple storage stacks, to store the preliminary GIS data layers, aerial photograph images, plot data and knowledge base of expert system.

The system may include processing server/computer 208 with GIS software package, RS software package, database package, such as ESRI ArcGIS, ERDAS Imagine, and Structured Query Language (SQL) server respectively. The processing server runs the backend/server end process to analyze, classify aerial photographs, synthesize GIS data layers, analyze data, generate reports and maps. A PDA 210 with GPS/GIS capabilities may be included, which can be used in the field to collect data and one interface to submit data and view delineation maps. The system also may include printer/plotter 212 to make hard copy of reports and maps. A scanner 214 may be included to scan photographs, field notes, and related research documents.

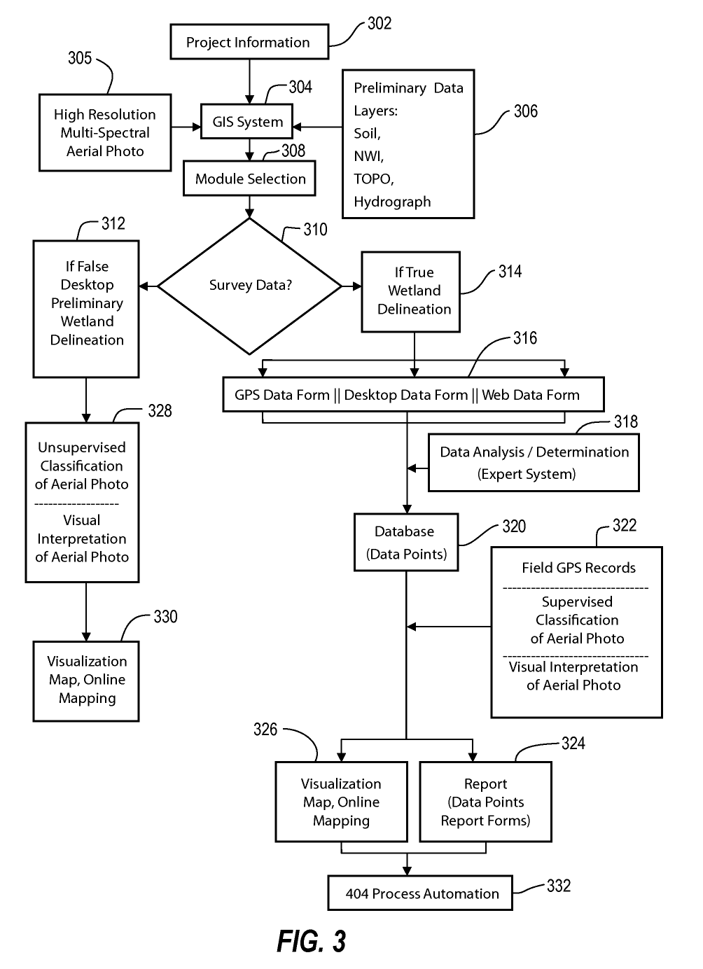

A flowchart illustrating the operations and logic the process utilizes for delineating wetlands is given in FIG. 3. The project information is collected in step 302 through a GIS system 304. High resolution, multi-spectral aerial photographs can also be obtained in step 305 to be used in later steps. Based on the project information, the preliminary data sets are obtained in step 306 and the manual and module suitable for the AOI is selected in step 308, such as Alaska Delineation Module, Arid West Delineation Module, Arizona, New Mexico Mountains Wetlands, Atlantic and Gulf Coastal Plain Module, California Wetlands, Caribbean Islands Module, Columbia Snake River Basin Wetlands, Great Plains Module, Hawaii and Pacific Islands Module, Interior Deserts Wetlands, Mediterranean California Wetlands, Eastern Mountains and Piedmont Module, Midwest Module, Northcentral and Northeast Module, Pacific Islands Module, Sierra Nevada Mountains Wetlands, Western Mountains Valleys & Coast Module.

If field survey data has not been collected in step 310, a preliminary desktop delineation is conducted using the preliminary data in step 312. If field data has been collected, detailed wetland delineation is conducted in step 314. In step 316, field data may be submitted to the database through PDA, Desktop or Web form. The submitted data in step 318 is assessed by the expert system to determine whether or not the surveyed area is wetland (details of logic utilized by the expert system are provided in FIGS. 4 through 6 and 7 through 9). The determination results together with the survey data are stored in the database in step 320. In step 332, the wetland boundaries are delineated based on field GPS/GIS records, unsupervised classification and supervised classification using the surveyed points as testing sites, aerial photograph, and remote sensing techniques. The report and the delineation map are created and prepared in step 322 for submittal as part of the Section 404 application process in step 324. The process can also display the visualization through a map or online mapping system in step 326. In step 332, the process finally may include automating the Section 404 process with the input project information, site condition, and the wetland delineation report and maps.

If field survey data has not been collected in step 310, the preliminary desktop delineation is conducted in step 312. In step 328, the wetland boundaries are delineated based on unsupervised classification and/or visual interpretation. The process can display the visualization through a map or online mapping system in step 330.

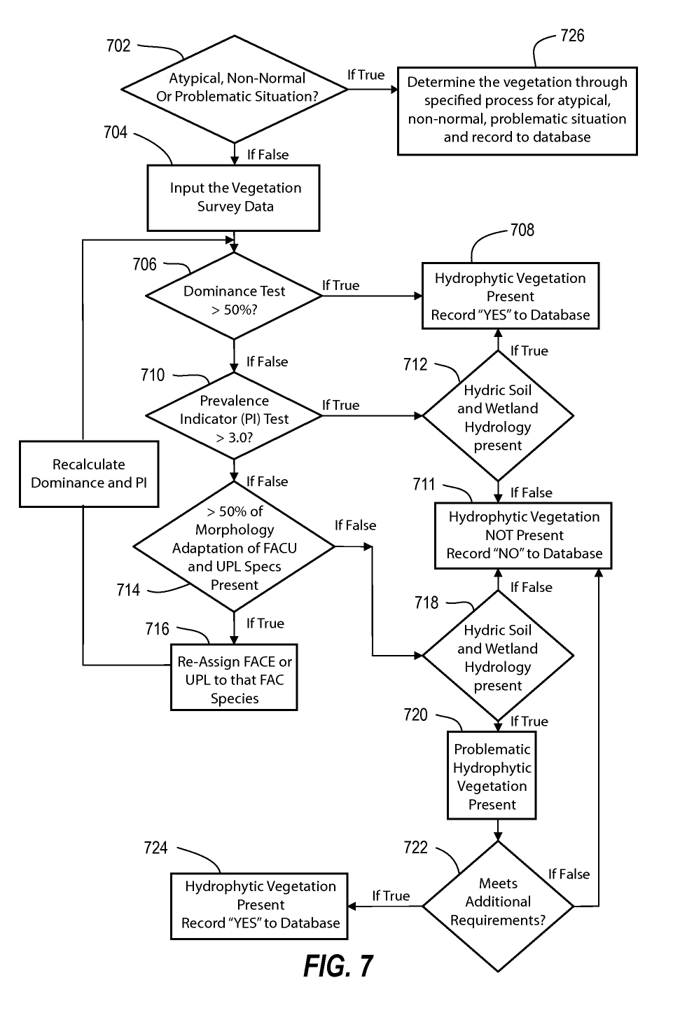

Flowcharts illustrating the operations and logic the expert system uses to determine the hydrophytic vegetation presence, hydric soil presence, and wetland hydrology presence indicators, following the 1987 Manual and Arid West Supplement, respectively are provided in FIGS. 4 through 6 and 7 through 9. Other processes can be implemented in a similar manner to determine hydrophytic vegetation presence, hydric soil presence, and wetland hydrology presence indicators using the supplements for other regions in the US and its Territories. The processes would implement a similar flow pattern as discussed with respect to FIGS. 7 through 9 below by substituting the specific data and results needed for those regions.

FIGS. 4-6 illustrate the process of analyzing field data under the 1987 Manual. If specific regional supplements have not yet been developed then the regulations require the analysis to be conducted under the 1987 Manual. As criteria for specific regions are developed, a separate process will be tailored to the region. For example, FIGS. 7-9 illustrate the Arid West region.

In FIG. 4, the hydrophytic vegetation presence determination is shown using the 1987 Manual. The process starts by determining whether an atypical situation exists in step 402 from field surveys. If not, vegetation survey data is inputted in step 404. A drop down menu from the knowledge base can be provided to help the user. After the vegetation data has been entered, a dominance test is conducted by the expert system in step 406. If greater than 50% dominant species are Obligate Wetland Plants (OBL), Facultative Wetland Plants (FACW) or Facultative Plants (FAC), then hydrophilic vegetation is present and “Yes” is recorded to the database in step 408. Additional indicators may be added to strengthen the case for the presence of hydrophytic vegetation in step 409. If not, the process proceeds to step 410, where the system determines whether hydric soil and wetland hydrology indicators are present. If so, problematic hydrophytic vegetation is present in step 412 and the system delineates methods and steps in problem areas in step 414. If hydrophytic vegetation is present, then “Yes” is recorded in the database in step 416. If no hydrophytic vegetation is present, then “No” is recorded in the database in step 418. Additionally, if no hydrophytic vegetation is found in step 410, then the process proceeds to step 418, where “No” is recorded in the database.

If an atypical situation exists in step 402, then the system determines the type of alteration, effects of alteration on vegetation, and provides documentation on previous vegetation in step 420. The system then determines whether previous vegetation is hydrophytic vegetation in step 422 and records information to the database.

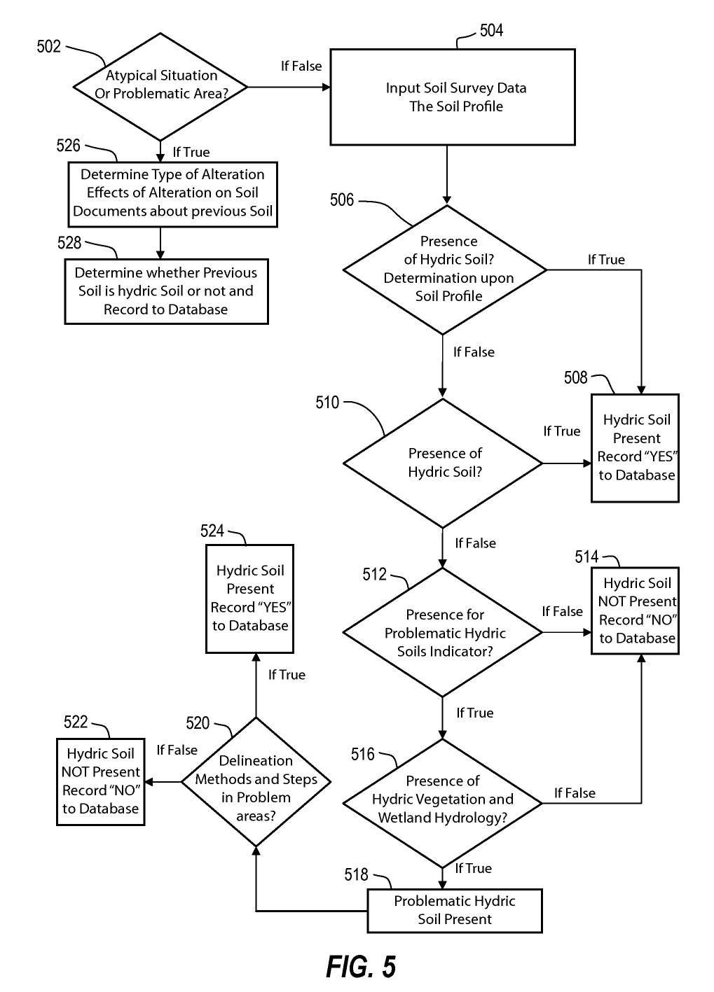

In FIG. 5, the hydric soil presence determination is shown using the 1987 Manual. The process starts by determining whether an atypical situation exists in step 502 from field surveys. If not, soil survey data is inputted in step 504. A drop down menu from the knowledge base can be provided to help the user. After the soil data has been entered, a soil profile is conducted by the expert system in step 506. If hydric soil is present, “Yes” is recorded to the database in step 508. If not, additional hydric soil indicators may be added to strengthen the case in step 510. If hydric soil is present, “Yes” is recorded to the database in step 508. If not, the process proceeds to step 512, where the system determines whether problematic hydric soil indicators are present. If no hydric soil is present, then “No” is recorded in the database in step 514. If so, then the system determines whether problematic hydrophytic vegetation and wetland hydrology is present in step 516. If no hydrophytic vegetation is present, then “No” is recorded in the database in step 514. If hydrophytic vegetation is present, then problematic hydric soil is present in step 518. In step 520, the system delineates methods and steps in problematic areas. Based on the delineation, if the system finds no hydric soil present, then “No” is recorded in the database in step 522. If hydric soil is found to be present in step 520, then the process proceeds to step 524, where “Yes” is recorded in the database.

If an atypical situation exists in step 502, then the system determines the type of alteration, effects of alteration on soil, and provides documentation on previous soil in step 526. The system then determines whether previous soil is hydric soil in step 528 and records information to the database.

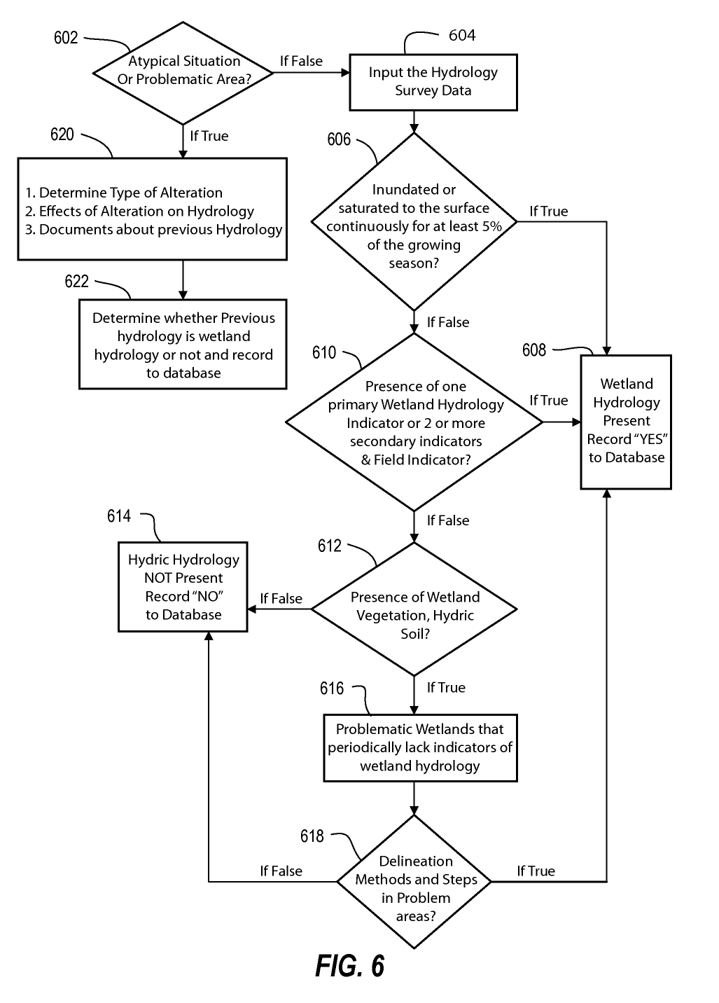

In FIG. 6, the wetland hydrology presence determination is shown using the 1987 Manual. The process starts by determining whether an atypical situation exists in step 602 from field surveys. If not, wetland hydrology survey data is inputted in step 604. After the wetland hydrology data has been entered, the system determines whether the hydrology is inundated or saturated to the surface continuously for at least 5% of the growing season in step 606. An example of this determination is discussed in Carpenter, L. A., An Approach for Delineation Hydrologic Boundaries of Wetlands by Simulating Long-Term Climatic Conditions, August 2000, Masters Thesis, University of Nevada, Reno, Master of Science Hydrology/Hydrogeology. If wetland hydrology is present, “Yes” is recorded to the database in step 608. If not, the system determines whether one primary wetland hydrology indicator or two or more secondary wetland hydrology indicators and field indicators are present in step 610. If wetland hydrology is present, “Yes” is recorded to the database in step 608. If not, the process proceeds to step 612, where the system determines whether wetland vegetation or hydric soil are present. If no, then “No” is recorded in the database in step 614. If so, then the system identifies problematic wetlands that periodically lack indicators of wetland hydrology in step 616. In step 618, the system delineates methods and steps in problematic areas. Based on the delineation, if the system finds no hydric hydrology is present, then “No” is recorded in the database in step 614. If wetland hydrology is present in step 618, then the process proceeds to step 608, where “Yes” is recorded in the database.

If an atypical situation exists in step 602, then the system determines the type of alteration, effects of alteration on hydrology, and provides documentation on previous hydrology in step 620. The system then determines whether previous hydrology is wetland hydrology in step 622 and records information to the database.

FIGS. 7-9 illustrate the method of analyzing survey data from the Arid West. Other regions, such as Alaska, Western Mountains, Valleys & Coast, Great Plains, Midwest, Northcentral and Northeast, Eastern Mountains and Piedmont, Atlantic and Gulf Coastal Plain, Caribbean Islands, and Pacific Islands would be configured in a similar manner other than adding specific criteria for the particular region under analysis.

As an example, in FIG. 7 the hydrophytic vegetation presence determination is shown using the Arid West Supplement. The process starts by determining whether an atypical situation, non-normal circumstance, or naturally problematic situation exists in step 702 from field surveys. If not, vegetation survey data is inputted in step 704. A drop down menu from the knowledge base can be provided to help the user. After the vegetation data has been entered, a dominance test is conducted by the expert system in step 706. If greater than 50% dominant vegetation is hydrophytic vegetation, then wetland vegetation is present and “Yes” is recorded to the database in step 708. If not, a prevalence indicator (PI) test is conducted by the expert system in step 710. If the result of the PI is less than 3.0, the process proceeds to step 712 and hydric soil and wetland hydrology indicators are present, then hydrophytic vegetation is present and “Yes” is recorded in the database in step 708. If not, the expert system determines that the hydrophytic vegetation is not present and “No” is recorded in the database in step 711.

If the result of the PI is greater than 3.0 and greater than 50% of the Facultative Upland (FACU) and Obligate Upland Plants (UPL) vegetation species have morphology adaptation, as determined by the expert system in step 714, then assign FACU and UPL to FAC in step 716 and redo the dominant test in step 706. Else, if the result of the PI is greater than 3.0 and less than 50% of the FACU and UPL vegetation species have morphology adaptation, the expert system determines whether hydric soil and wetland hydrology indicators are present in step 718. If these two indictors are not present, then the hydrophytic vegetation is not present and “No” is recorded in the database in step 711.

If the other two indicators are present, then problematic hydrophytic vegetation is present in step 720. The expert system then checks whether additional requirements are met in step 722. If additional requirements are met, then hydrophytic vegetation is present and “Yes” is recorded in the database in step 724. Otherwise, the expert system determines that the hydrophytic vegetation is not present and “No” is recorded in the database in step 711.

If an atypical situation, non-normal circumstance or naturally problematic situation does exist in step 702, then the system proceeds to step 720 and follows the process to make the determination.

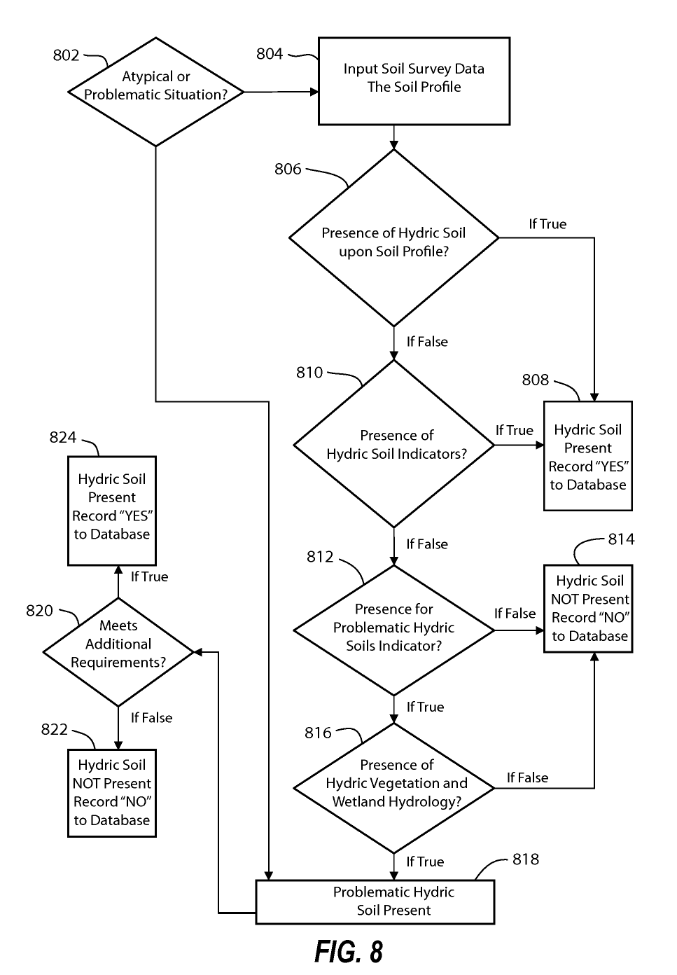

In FIG. 8, the hydric soil presence determination is shown for the Arid West region. The process starts by inputting survey data for the soil profile in step 802. A drop down menu from the knowledge base can be provided to help the user input the necessary data. After the soil data has been entered, a soil profile is determined by the system in step 804. From the soil profile analysis, if hydric soil is present, “Yes” is recorded to the database in step 806. If not, additional hydric soil indicators may be added to strengthen the case in step 808. If hydric soil is present based on the additional indicators that were added in step 808, “Yes” is recorded to the database in step 806. If not, the process proceeds to step 810, where the system determines whether problematic hydric soil indicators are present. If no hydric soil is present, then “No” is recorded in the database in step 812. If so, then the system determines whether problematic hydrophytic vegetation and wetland hydrology is present in step 814. If no hydrophytic vegetation is present, then “No” is recorded in the database in step 812. If hydrophytic vegetation is present, then problematic hydric soil is present in step 816. In step 818, the system delineates methods and steps in problematic areas. Based on the delineation, if the system finds no hydric soil present, then “No” is recorded in the database in step 820. If hydric soil is found to be present in step 818, then the process proceeds to step 822, where “Yes” is recorded in the database.

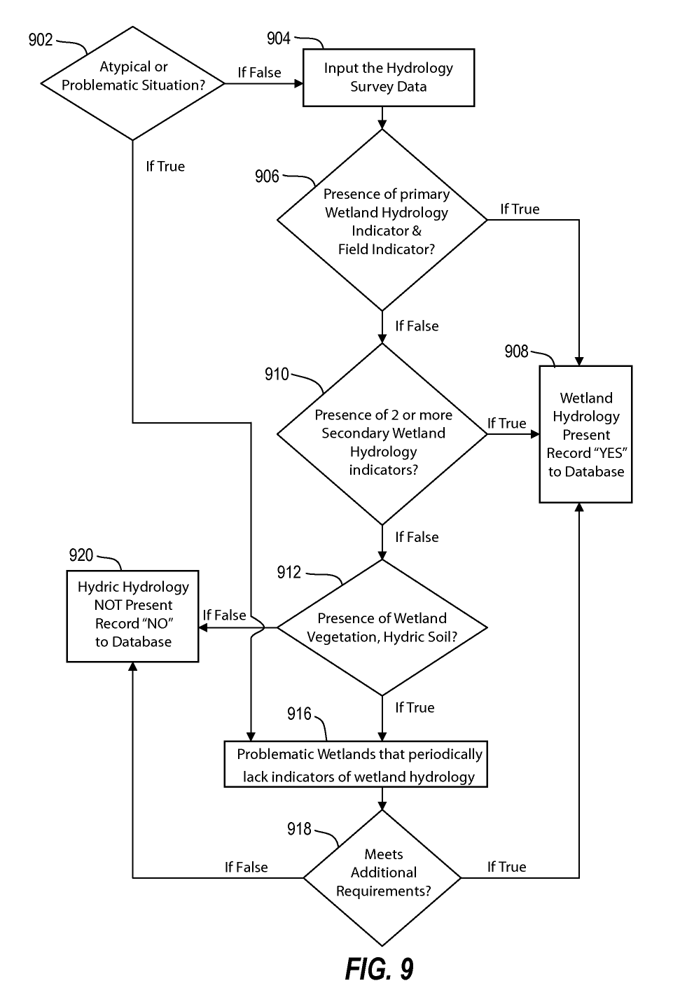

FIG. 9 illustrates the wetland hydrology presence determination for the Arid West region. The process starts by inputting wetland hydrology survey data in step 902. After the wetland hydrology data has been entered, the system determines whether a primary wetland hydrology indicator and field indicator are present in step 904. An example of this determination is discussed in Carpenter, L. A., An Approach for Delineation Hydrologic Boundaries of Wetlands by Simulating Long-Term Climatic Conditions, August 2000, Masters Thesis, University of Nevada, Reno, Master of Science Hydrology/Hydrogeology. If wetland hydrology is present, “Yes” is recorded to the database in step 906. If not, the system determines whether two or more secondary wetland hydrology indicators are present in step 908. If wetland hydrology is present, “Yes” is recorded to the database in step 906. If not, the process proceeds to step 910, where the system determines whether wetland vegetation or hydric soil are present. If no, then “No” is recorded in the database in step 912. If so, then the system identifies problematic wetlands that periodically lack indicators of wetland hydrology in step 914. In step 916, the system delineates methods and steps in problematic areas. Based on the delineation, if the system finds no hydric hydrology is present, then “No” is recorded in the database in step 912. If wetland hydrology is present in step 916, then the process proceeds to step 906, where “Yes” is recorded in the database.

The processes for other regions would implement a similar flow pattern as discussed above with respect to FIGS. 7 through 9 by substituting the specific data and results needed for the particular region. To avoid duplicating this information, a discussion of the other regions will not be discussed. The data from the others regions such as Alaska, Western Mountains, Valleys & Coast, Great Plains, Midwest, Northcentral and Northeast, Eastern Mountains and Piedmont, Atlantic and Gulf Coastal Plain, Caribbean Islands, and Pacific Islands would be implemented in a similar manner to the Arid West Supplement example discussed above.

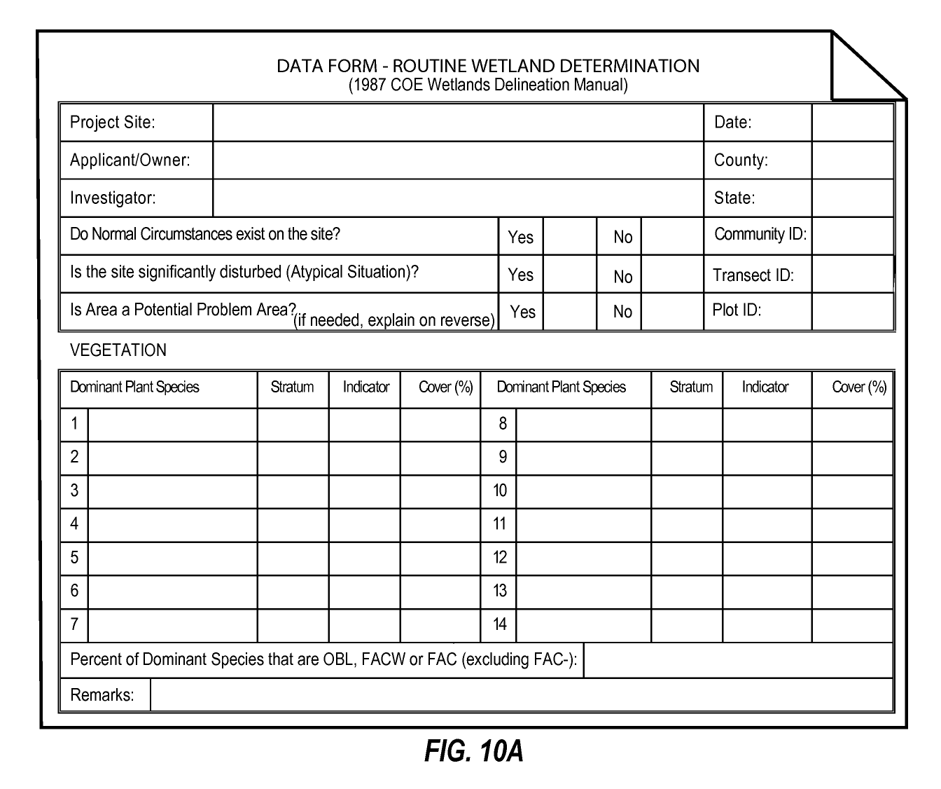

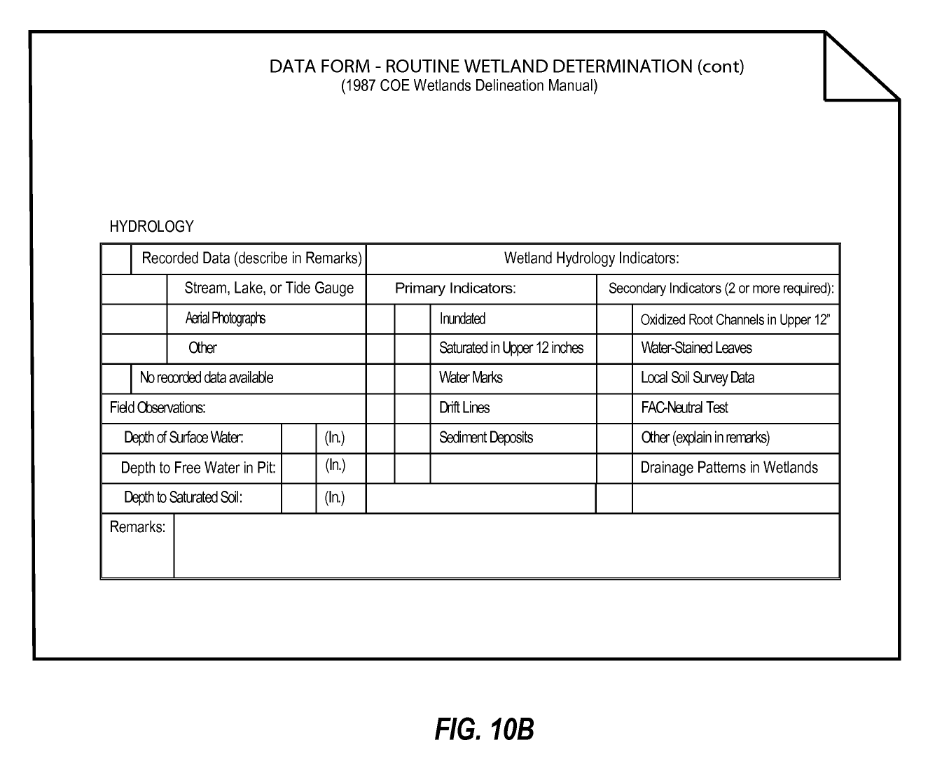

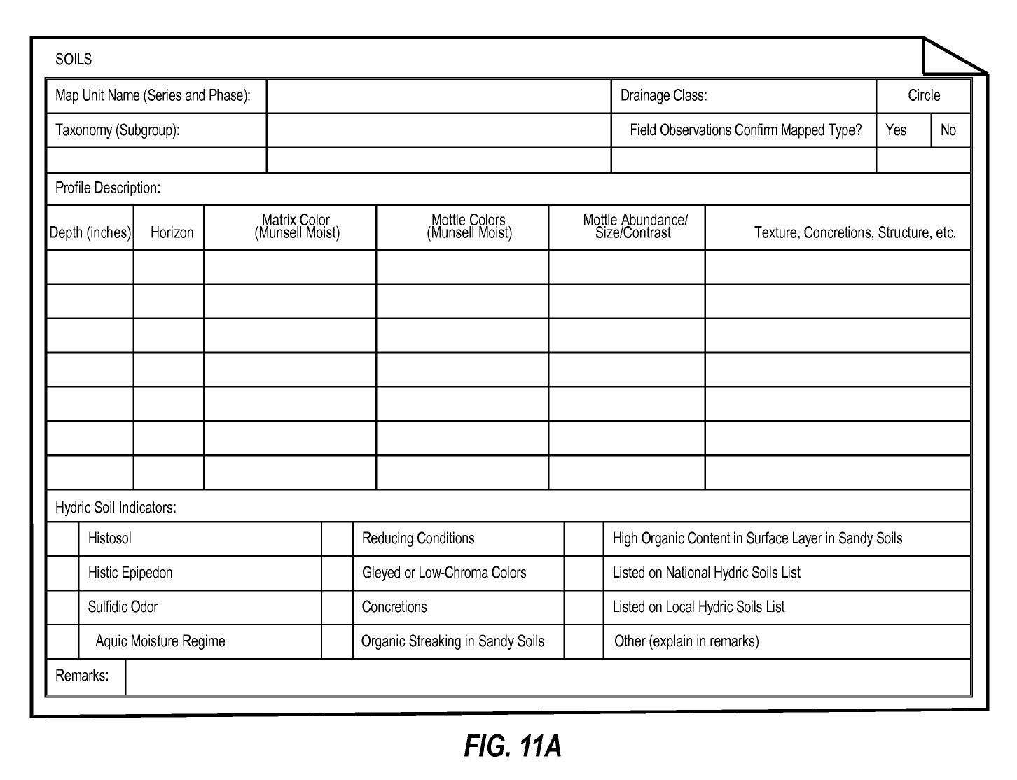

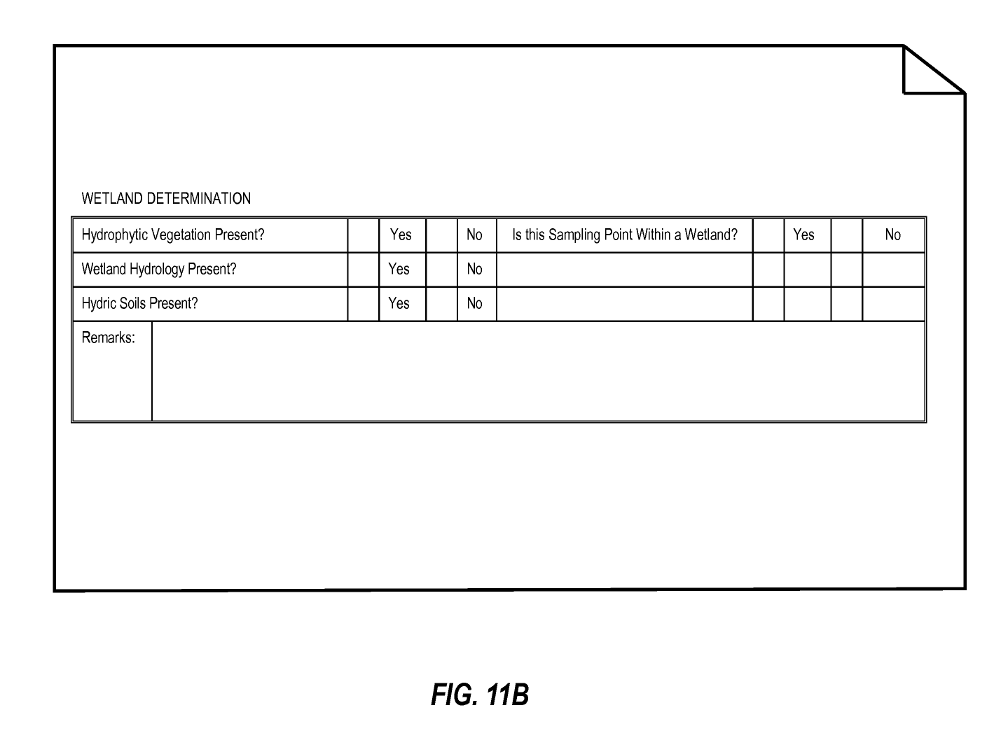

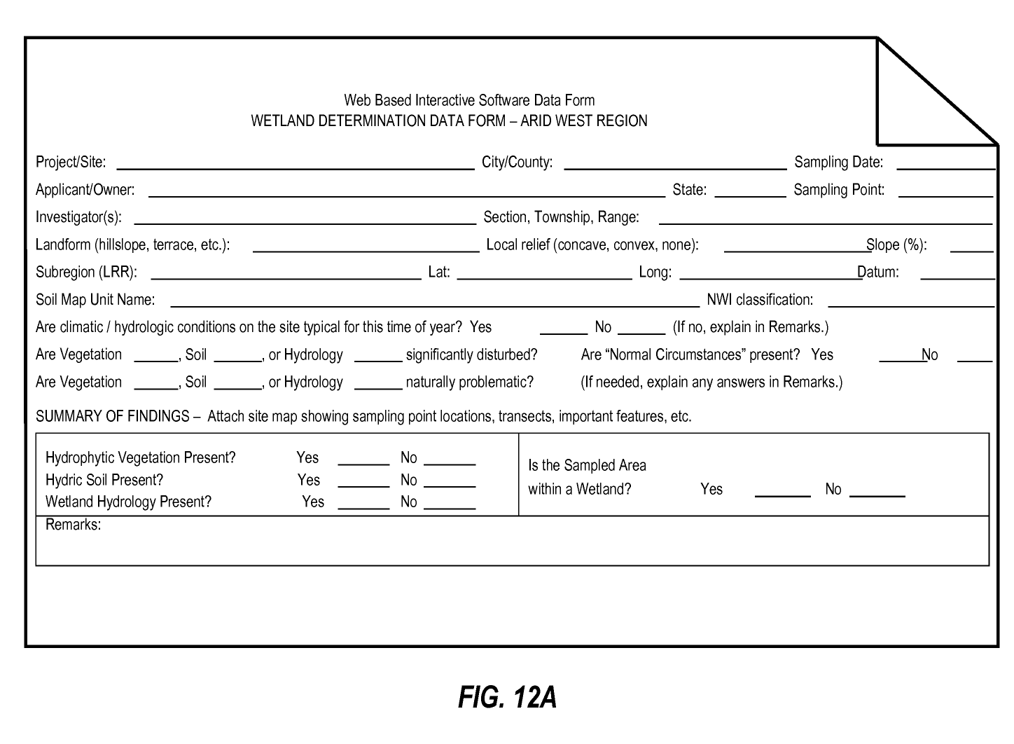

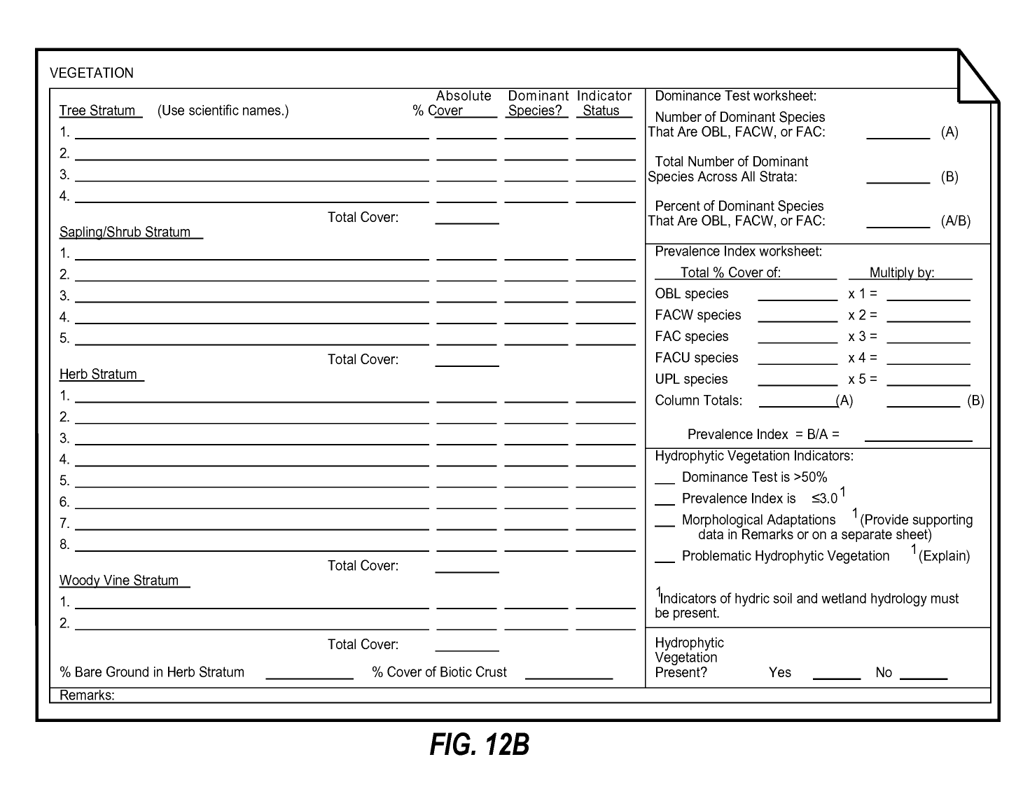

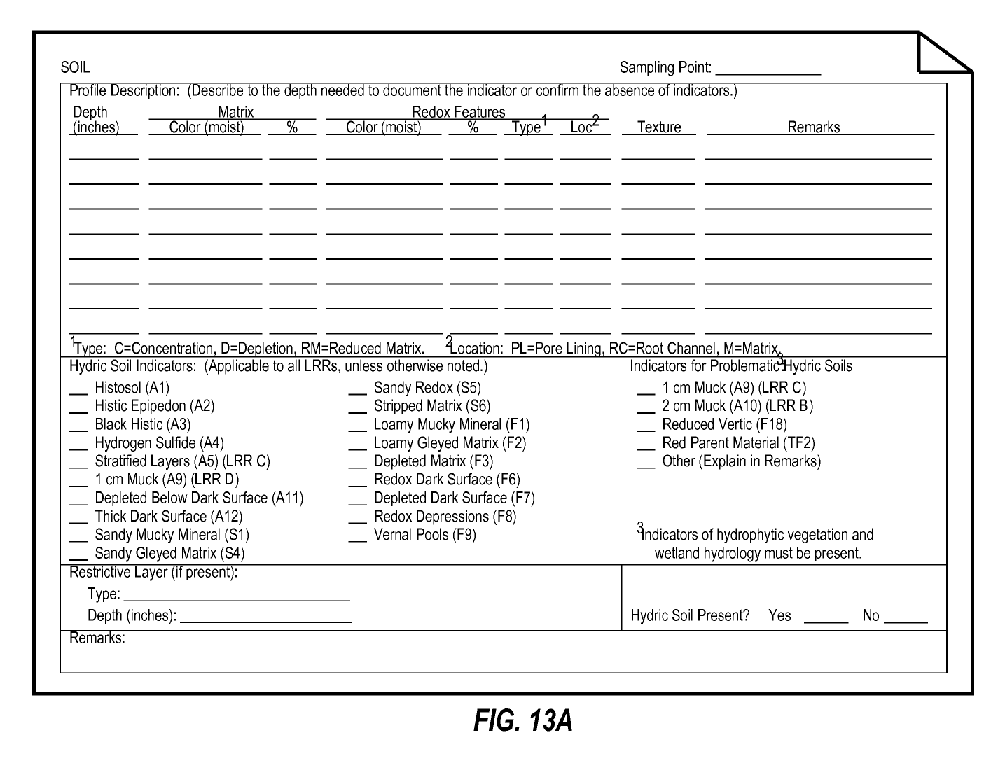

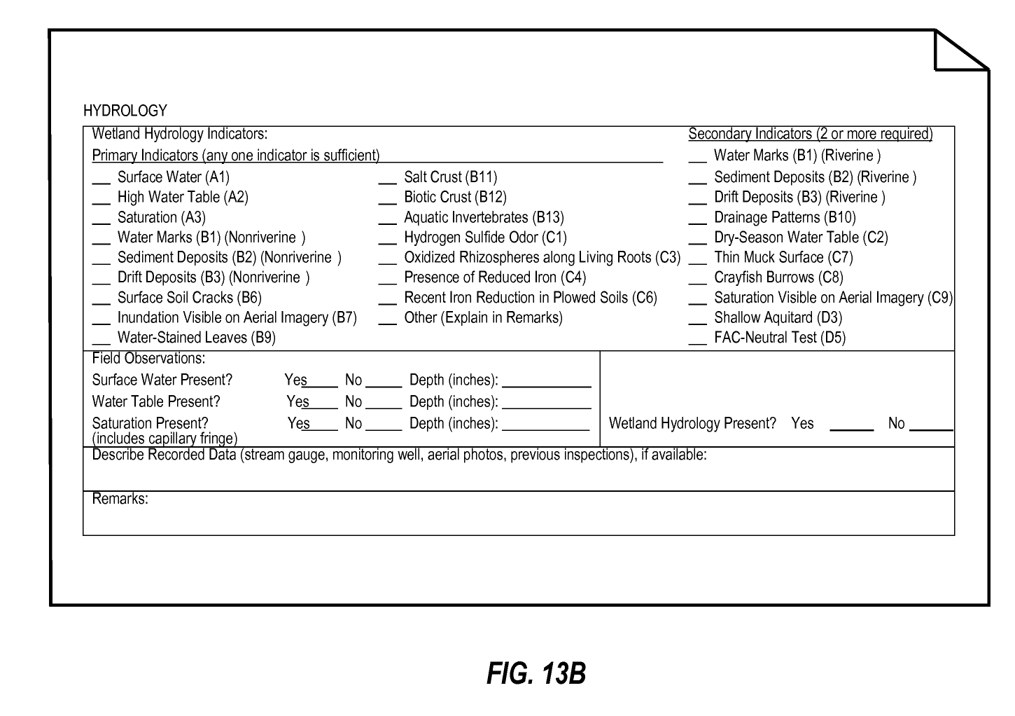

Examples of the standardized data forms for 1987 Manual and Arid West Supplements are given in FIGS. 10-13. These forms are used as templates to design both the data input forms and standard report forms for the invention.

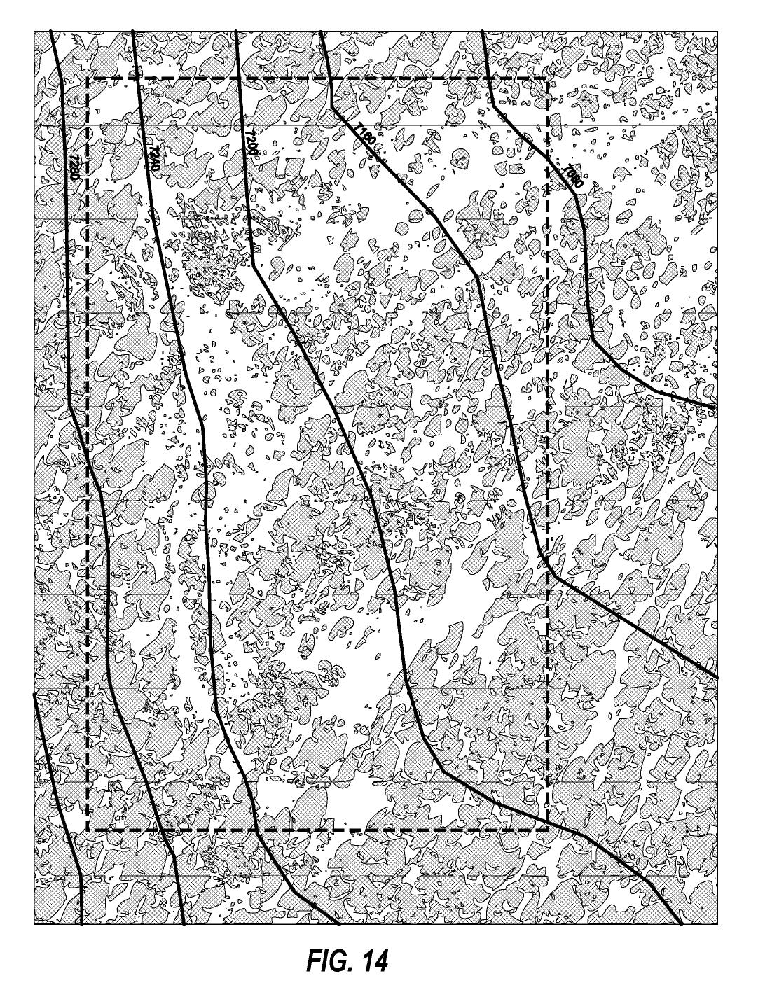

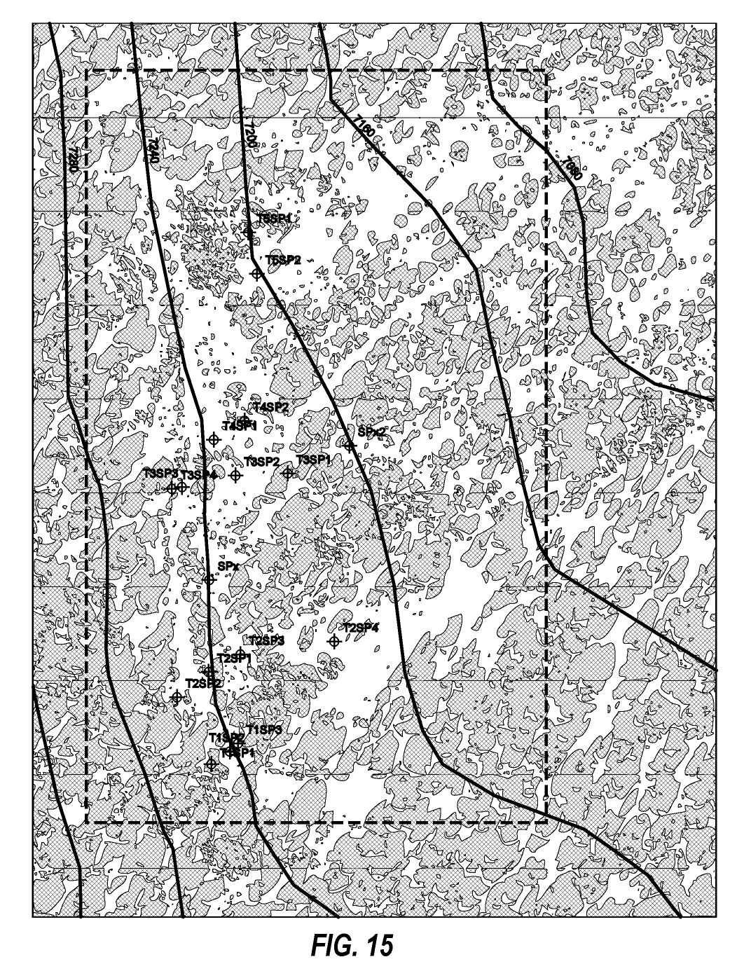

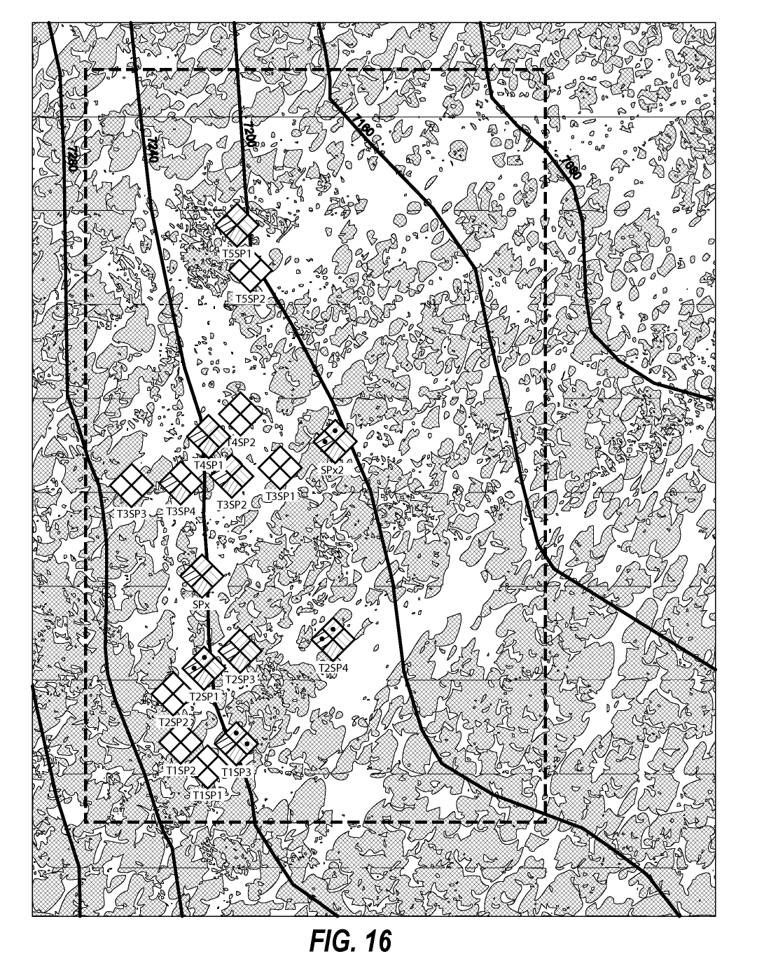

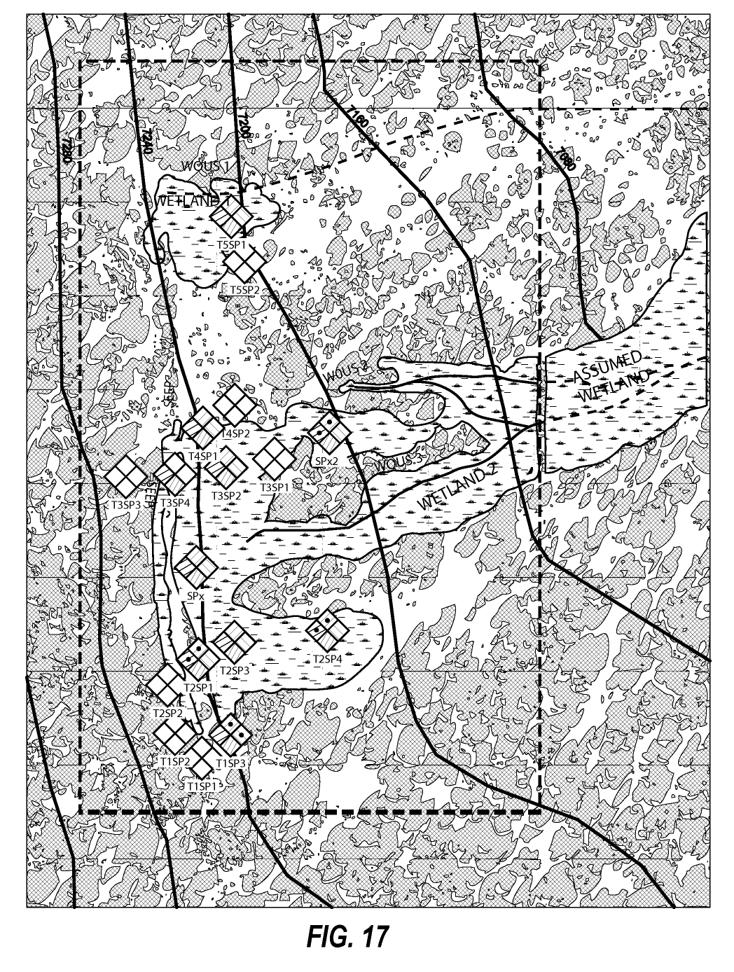

An example of an application of the invention to delineate the wetland of a project site is given in FIGS. 14 through 17. FIG. 14 is an illustration of a project site overlaid on a high resolution aerial photograph, FIG. 15 is an illustration of the survey plot locations on the aerial photograph, FIG. 16 is an illustration of the plots with determined indicators on the aerial photograph, and FIG. 17 is an illustration of the wetland boundary delineated on the aerial photograph.

Examples of the system may include or be conducted using a special purpose or general-purpose computer, processor, or logic device including various computer hardware and devices, as discussed in greater detail herein or known to one of ordinary skill in the art. Embodiments within the scope of the present system can also include computer-readable media for carrying or having computer-executable instructions or data structures stored thereon. Such computer-readable media can be any available media that can be accessed by a general purpose computer, special purpose computer, or a logic device. By way of example, and not limitation, such computer-readable media can comprise Random-Access Memory (RAM), Read-Only Memory (ROM), Electrically Erasable Programmable Read-Only Memory (EEPROM), Compact Disk Read Only Memory (CD-ROM) or other optical disk storage, magnetic disk storage or other magnetic storage devices, or any other medium which can be used to carry or store desired program code means in the form of computer-executable instructions or data structures and which can be accessed by a general purpose computer, special purpose computer, or other logic device.

When information is transferred or provided over a network or other communication connection (either hardwired, wireless, or a combination of hardwired or wireless) to a computer, the computer can properly view the connection as a computer-readable medium. Thus, any such connection is properly termed a computer-readable medium. Various combinations of the above should also be included within the scope of computer-readable media. Computer-executable instructions comprise, for example, instructions, logic, and data which cause a general purpose computer, special purpose computer, or logic device to perform a certain function or group of functions.

Each of the processors described herein can be a single conventional general purpose computer, special purpose computer, or logic device, or each processor can be multiple processors including multiple conventional general purpose computer, special purpose computers, or multiple logic devices. Moreover, many of the functions that take place using a processor can be implemented on other types of logic devices, such as programmable logic devices. In addition, additional processors, logic devices, or hardware may be implemented to carry out a given function or step according to additional embodiments of the system. For example, additional processors may be implemented for storage and retrieval of data as is known to one of ordinary skill in the art. Such details have been eliminated so as to not obscure the invention by detail.

In one example, a Wetland Delineation Interactive System is provided. The system can include an input interface. The interface can be accessed through a usage subscription and/or service request, i.e. online request, facsimile transmission, onsite request, e-mail, or through other known methods of communication to request service. The system can also include access to the Wetland delineation module selection (1987 Manual, Arid West, Alaska, Great Plains, Northwest Region, Midwestern, Western, Southern, Northeastern, and the like). The interface can include a data input interface, such as GPS/GIS data forms, desktop data forms, web data forms for computer, portable, handheld, and mobile phone access, Wireless Application Protocol (WAP) data forms, and the like. The data can be transferred and/or synchronized through hard line connections, such as cable modems, Digital Subscriber Line (DSL), and the like, or wireless connections, such as a global network connection, Wireless Fidelity (Wi-Fi), Bluetooth, and the like.

The system can also include a database to manage the survey data. The survey data may include information such as point data, field photographs, or other field collected data and the like. The database can also be used to generate a data point report based on the survey data. A Geo-database and/or spatial database may also be included to manage the GIS background layer and to create maps and overlays. An image database may be included in the system to collect and manage remote sensing images, such as Landsat, IKONOS, and the like. The databases discussed above may include an integrated database system, multiple databases networked together, multiple databases integrated together with support of a database with spatial capability, a single database, and any other configuration known to store and manage data.

The system can also include a backend service component that is configured to analyze the data points, such as Wetland Point Determination, for example, Wetland Vegetation, Hydric Soil, Wetland Hydrology Sub-Blocks, and the like. The back end service component can also be configured to classify multi-spectral images from supervised or unsupervised classifications, or visual interpretations by using ERDAS Imagine, ENVI, or other remote sensing software package and the like. The backend service component can also be configured to generate a report based on the results of the data point analysis. An interface can be incorporated to provide visualization and/or map making capacity. The backend service component may be configured by way of the GIS to provide the visualization and map making through ArcGIS, Mapinfo, Grass, or other GIS software package and the like.

The system also can include a data warehouse. The data warehouse can be configured to store aerial photographs and collections. These images can be purchased from a third party source if not already found in the warehouse. Images can be collected and stored from field surveys as needed. The data warehouse can cooperate with an image provider. For example, a third party account can be established to use Google Earth, Microsoft Earth, or other mapping service and the like. In addition, images can be used for the visualizations and service requests. The data warehouse can also use background GIS data sets. The data sets can be pre-collected and stored or ready to be used for projects in the covered regions or areas. A soil database can be included in the data warehouse. The soil database can be used to facilitate input and determination of soil criteria. The data warehouse can further include a vegetation database that is configured by state, county or region. The vegetation database can be used to facilitate the input and determination on vegetation criteria.

Furthermore, the system can include an output interface. The output interface can include a hardcopy report form that incorporates the data points. The forms are designed to be used with the CORPS wetland delineation report form. The hardcopy report can also include a delineation map, which is produced from a map template in the system. The output interface can also include an online report form to be downloaded and/or printed by users. One more feature of the output interface can be an online delineation map. The online delineation map can be provided to the users for review and/or printed out. A map template can also be used for the delineation map. The maps can be configured to incorporate ArcIMS, Mapserver, Mapguide, or other webGIS tools and the like.

Employees of Federal Agencies involved in the Section 404 process will have numerous personnel retiring. These personnel represent key senior staff that can mitigate through the complex delineation and regulatory/environmental process. They will not have the time to train new staff and may not even be able to hire staff quickly enough to keep up with the number of permit applications.

Environmental permits are needed in all development projects within the US Federal Government, US Army Corps of Engineers and Environmental Protection Agency (EPA) agencies. Professionals, regulators, consultants, and lawyers must understand and be proficient within key federal acts and laws related to the National Environmental Policy Act, Clean Water Act, Threatened and Endangered Species Act, Historic Preservation and various farm bills. Previously, third party consulting services were limited to the geographic areas within travelling distance. With the on-demand, web-based interactive data-base multitenancy software model format, users can compete in any market in the US and finalize the process faster than a scientific consultant who lives in that area.

The on-demand, web-based interactive data-base multitenancy software model format is core technology that provides a competitive advantage. The ability to open an office in any town, anywhere in the US has led large competitors to out price and out smaller consulting firms. Presently, large firms take advantage of the inefficiency within the industry standard because they employ high-priced senior staff. This system gives small competitors an advantage.

The ability to stay on top of the law-policy-science has literally left individual scientists and regulators exhausted and close to burnout. Frustration in all sides of the environmental fences has left many development projects at a very expensive impasse. Now, the scientist, regulator, lawyer, whether novice or expert, can focus on the higher level environmental problems because the software product reduces redundant tasks and can maintain the “rest” of the system allowing them to focus on their clients and projects. This will result in better, local, creative human based solutions necessary to bring the real issues to the table whether economic, development, construction, or simply preservation. Because this will save both time and money and allow a land developer and regulatory the ability to predict an outcome it will be invaluable.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In an interactive database driven multitenancy system, a method comprising:
providing a user interface for selecting a regional supplement;
obtaining an orthorectified aerial photograph for the selected regional supplement;
overlaying the aerial photograph with a boundary of a selected project;
providing a user interface for obtaining preliminary data set of NWI, Soil, Hydrology, and TOPO;
conducting a wetland delineation; and
generating a wetland delineation report.

2. The method of claim 1, further comprising providing a user interface for selecting a relevant supplement manual and method from a list, the manual and method corresponding to data associated with corresponding governmental regulations and stored in a database.

3. The method of claim 1, further comprising comparing the preliminary data set with information related to aerial imagery.

4. The method of claim 3, further comprising providing a choice aerial imagery related to the preliminary data set.

5. The method of claim 4, further comprising obtaining aerial imagery related to the preliminary data set from a third party source.

6. The method of claim 1, further comprising providing a user interface for obtaining field technician plot survey data.

7. The method of claim 6, further comprising accessing a data form related to the plot survey data and inputting the plot survey data into the data form.

8. The method of claim 7, further comprising storing the plot survey data in a database server.

9. The method of claim 7, further comprising preparing a plot data report and a delineation map from the plot data.

10. The method of claim 1, further comprising identifying wetland delineation indicators in hydrophytic vegetation, hydric soil, and wetland hydrology from the system.

11. The method of claim 1, further comprising delineating a boundary of Waters of United States (WOUS)/Wetlands by either adjusting the boundaries, recording data in the field using a GPS/GIS, or by drawing the boundaries by interpreting and classifying the aerial photographs.

12. The method of claim 1, wherein conducting a wetland delineation includes conducting a preliminary desktop wetland delineation.

13. The method of claim 1, wherein conducting a wetland delineation includes conducting a detailed wetland delineation and generating a detailed wetland delineation report.

14. In an interactive database driven multitenancy system, a method comprising:
providing a user interface for inputting data from field surveys into a database;
analyzing the data and determining if the data is greater than about 50% dominant vegetation, then assigning an affirmative value to the data to indicate that wetland vegetation is present;
if the wetland vegetation is less than about 50% dominant, then conducting a prevalence indicator test;
if the prevalence test result is less than about 3.0, then assigning an affirmative value to the data to indicate that wetland vegetation is present; and
If the prevalence test result is greater than about 3.0, then assigning a negative value to the data to indicate that no wetland vegetation is present.

15. The method of claim 14, wherein if the result of the prevalence test is greater than about 3.0 and the data shows that FACU and UPL vegetation species have morphology adaptation greater than about 50% as determined by the system, then the system assigns the FACU and UPL to FAC and analyzes the data.

16. The method of claim 14, wherein if the result of the prevalence test is greater than about 3.0 and the data shows that the FACU and UPL vegetation species have morphology adaptation less than about 50% as determined by the system, then the system determines whether hydric soil and wetland hydrology indicators are present.

17. The method of claim 16, wherein if the hydric soil and wetland hydrology indicators are not present, then a negative value is recorded in the database to indicate that hydrophytic vegetation is not present.

18. The method of claim 16, wherein if the hydric soil and wetland hydrology indicators are present, then the system determines whether additional requirements are met.

19. The method of claim 18, wherein if the additional requirements are met, then an affirmative value is recorded in the database to indicate that hydrophytic vegetation is present.

20. The method of claim 18, wherein if the additional requirements are not met, then a negative value is recorded in the database to indicate that hydrophytic vegetation is not present.
